(19) United States
(12) Patent Application Publication
(10) Pub. No.: US 2005/0019561 A1
(43) Pub. Date: Jan. 27, 2005

(54) Profiled part and aggregates for making same

(76) Inventors: Jochen Gassan, Eschwege (DE); Rudolf Einsiedel, Sooden-Allendorf (DE); Hans-Peter Fink, Teltow (GB); Peter Weigel, Kleinmachnow (DE)

Correspondence Address: Marshall & Melhorn, 8th Floor, Four SeaGate, Toledo, OH, 43604, US

(21) Appl. No.: 10/492,898

(22) PCT Filed: Oct. 17, 2002
(86) PCT No.: PCT/EP02/11651

(30) Foreign Application Priority Data
Oct. 17, 2001 (DE) 101513690

(51) Int. Cl. B32B 5/16

(52) U.S. Cl. 428/364; 264/141; 264/136; 428/402

(57) ABSTRACT

The invention concerns a profiled part and aggregates for making same. The aggregates contain a material for plastic matrix technique and an adherence promoter. Regenerated cellulose fiber elements are incorporated in the matrix material. The characteristic profile of a profiled part made from such aggregates corresponds substantially to that of profiled PC/ABS parts, the profiled part of the invention being, however, capable of being produced at a more advantageous cost, being more recyclable and being, moreover, capable of being shaped at lower temperatures.

The present invention relates to a moulded part, especially to be used in automotive vehicle interiors, and to granules for producing same.

Melting granules containing plastics material in an injection moulding process to form moulded parts is known. Thus it is customary for example, to use for the interior of automotive vehicles PC/ABS (polycarbonate/acrylonitrile-butadiene-styrene co-polymers) to produce such moulded parts. This material is of great interest above all in respect of its impact strength at low temperatures.

What is disadvantageous here, however, is the lack of availability or respectively the high costs of these granules. Moreover the capacity for being recycled and the styrene emission of this material are not satisfactory. A further disadvantage is the necessary high processing temperature of 260-290° C.

Other granules for producing moulded parts are also known. Thus for example so-called short-fibre granules are known in which the plastics granules contain fibres which are less than 1 mm long. The moulded parts produced from this material have the disadvantage, however, that they have only very low impact strength.

Using glass-fibre granules with longer fibres as a basis for the moulded parts is also known. However these have the disadvantage that they have a high specific weight and moreover are not thermostable.

The impact strength at low temperatures is also not satisfactory.

Proceeding from this prior art, the object underlying the present invention is to make available a moulded part as well as granules for producing same which ensure that the moulded part can be produced cost-effectively on the basis of freely available constituents and nevertheless is impact-resistant at low temperatures.

This object is accomplished by granules according to claim 1 and by a moulded part according to claim 11 as well the manufacturing process for the granules according to claim 17.

Because the granules for producing moulded parts contain a matrix material formed from an engineering plastic and an adherence promoter and has fibre elements formed from regenerated cellulose bound into the matrix material, the desired properties of the moulded part are realised. So-called engineering plastics are easily available for this; this applies also to the adherence promoter and to the fibre elements formed from regenerated cellulose. It has been shown that, particularly through binding in regenerated cellulose fibre elements, significant advantages can be achieved e.g. in vehicle construction but also in other fields. It is thus possible to produce the entire interior finish of an automotive vehicle from a family of materials which are low in odour and emissions. In this connection the ability to re-use the materials in the sense of practised protection of the environment and the EU regulations on old cars is to be particularly stressed. The disadvantages existing for PC/ABS, i.e. the lack of availability and the high costs, do not exist for these granules. Nevertheless, the favourable properties profile of PC/ABS for vehicle interior parts in respect of the tensile strength, the notch impact strength and the elastic modulus is achieved practically at the same level. What is particularly advantageous is that the processing temperatures can be dropped to lower values than with PC/ABS by practically random selection of the engineering plastic.

What is absolutely essential for the invention is that regenerated cellulose fibres are used. By comparison with natural cellulose fibres or respectively also recycled natural cellulose fibres, these have critical and very surprising differences from the present invention. Under “regenerated cellulose” is understood here that this is cellulose which is recovered from solutions of cellulose or cellulose derivatives by precipitation processes mostly with specific shaping (obtaining fibres). A particular advantage of this regenerated cellulose is that it is available in a continuous (this means “endless”) form and moreover has an extremely homogenous properties profile, which is not the case with natural cellulose. It is easily available commercially and also offers for the granules, or respectively for the moulded part obtained from the granules, a constant quality.

The regenerated cellulose fibres have, in particular also in contrast to natural cellulose fibres in a later moulded part, the advantage that the impact strength of the moulded part is greatly improved even if the strength of the regenerated fibres is itself not better than with comparable natural fibres. Also by comparison with glass-fibre moulded parts, even with the same volume there is a similar strength of the later product, such that altogether there is a great saving in weight. What is also advantageous here is that products formed from regenerated cellulose fibres have a very balanced properties profile and a uniform “make-up” by comparison with products formed from natural cellulose fibres which scatter a larger spread.

The very favorable mechanical properties of the regenerated cellulose moulded parts by comparison with natural cellulose are all the more surprising if the structure of natural cellulose and that of regenerated cellulose is compared (cellulose II type compared with cellulose I type). Amazingly, the theoretically higher mechanical properties of natural cellulose are here not apparent in the moulded part or the granules according to the invention; on the contrary, surprising advantages of the regenerated cellulose are demonstrated, particularly with respect to resilience.

Advantageous developments of the present invention are given in the dependent claims.

It is advantageous that the engineering plastic has a processing temperature of below 240° C., preferably below 200° C. This engineering plastic can be a polyolefin, a polyolefin derivative, PVC or also a polyamide. Particularly advantageous is e.g. an optimised PP having a density of 0.905 g/cm³ and a melt index (230° C., 50 Newton) of 170 dg/min (commercially available as Stamylan P 412 MN 10 from the company DSM).

In the present case, for the regenerated cellulose a fibre having 1350 filaments and a linear density of 1.81 dtex (commercially available as Cordenka 700—registered trademark—of the manufacturer Acordis) has proved to be propitious. This is a typical high-performance cellulose fibre to be used as a tyre cord. One advantage of this is the noticeably higher strength of these fibres by comparison with textile viscose fibres.

Further suitable regenerated cellulose fibres can be manufactured according to the lyocell and carbamate processes.

Particularly suitable are fibre elements based on a fibre having a tensile strength of more than 400 MPa. It should be particularly stressed that the elongation at break of the fibre elements can be very high and specifically more than 5%, preferably more than 8%, particularly preferably more than 10%. This is a great advantage e.g. also by comparison with Kevlar fibres (registered trademark), which with a roughly comparable strength have a very much lower elongation at break. For example the regenerated cellulose fibre Cordenka 700 (registered trademark) has values of 1.496 g/cm³ density, tensile strength 885 MPa, tensile modulus 27 GPa and an elongation at break of 12%.

Thus fibres of the lyocell type can also be used.

The granules contain preferably 10-90% by weight fibre elements, preferably 20-42% by weight; 24-42% by weight are also possible.

Adherence promoters are added to the matrix material. These are for example maleic acid copolymer, isocyanate derivatives, silanes, dimethyl urea (DHU), polyvinyl alcohol (PVAL), polyvinyl acetate (PVAC) or the like. Here for improving the fibre-PP-matrix adhesion, maleic anhydride grafted copolymers (MAPP) have proved successful for example. The granules contain up to 10% by weight of the adherence promoter, preferably 2-4% by weight. Moreover the granules preferably contain ultraviolet stabilisers or further additives. The ultraviolet stabilisers can be already present in the engineering plastic or can be added as a separate additive.

The granules should preferably be available in lengths of 1-15 mm; the fibre elements contained therein should be correspondingly greater than 1 mm and up to 15 mm long.

Characteristic for the moulded part according to the invention is that it consists of melted granules according to the invention in the solidified state. It is suitable for large-scale production in that the production of the moulded part takes place in an injection moulding process. Here a great advantage by comparison with the processing of PC/ABS is that lower temperatures are necessary during the injection moulding process. Thus it is possible to limit the maximum temperature of the melted granules (on e.g. a PP base) to 190-210° C., preferably 200° C. The injection pressure is here roughly 50-700 bar. In the moulded part, the length of the fibre element pieces is preferably 1-8 mm. In order to achieve these long lengths, it is important that the fibre elements contained in the granules are not damaged very much. An injection moulding process which is gentle on the fibres is necessary in order not to let the size of the fibre element pieces in the later moulded part become too small. To this end there are measures known from long-fibre injection moulding of PP-EF, such as for example the choice of a special screw configuration or of matched processing parameters. In order to achieve the properties profile of PC/ABS in relation to the good impact strength at low temperatures, care should be taken to ensure that the fibre element pieces are if at all possible longer than 2 mm, it being particularly propitious if at least 15-40% of the fibre element pieces are 1.5-5 mm long.

The moulded part according to the invention is particularly to be recommended for dashboards or door trims of an automotive vehicle produced by known techniques (back injection or injection-compression moulding). Naturally also any other parts can be made from the granules, a particular advantage of the invention lying in the fact that parts which are low in odour and emission and which have high impact strength at low temperatures can thus be produced in a cost-effective manner. In addition to complete dashboards, it is naturally also possible just to produce inserts from the material according to the invention.

For the production of the granules according to the invention, a pultrusion process is particularly suitable in which a regenerated cellulose fibre is coated with an engineering plastic. Here it is particularly advantageous that the regenerated cellulose fibre can be present as a continuous fibre which can be evenly coated in the pultrusion die with uniform quality over any random length. Thereafter, the produced regenerated cellulose fibre strands, coated with the matrix polymer, are granulated, i.e. they are cut into smaller sections and dried. It is also possible thereafter to lead the material again through the extruder, and yet again thereafter. Before further processing in an injection moulding process, by means of which a moulded part according to the invention is produced, cooling of the produced granules should take place again however. An advantage of this procedure is the incorporation of regenerated cellulose fibres of a uniform length.

The figures serve to clarify the favorable properties of the material according to the invention by comparison with the known PC/ABS:

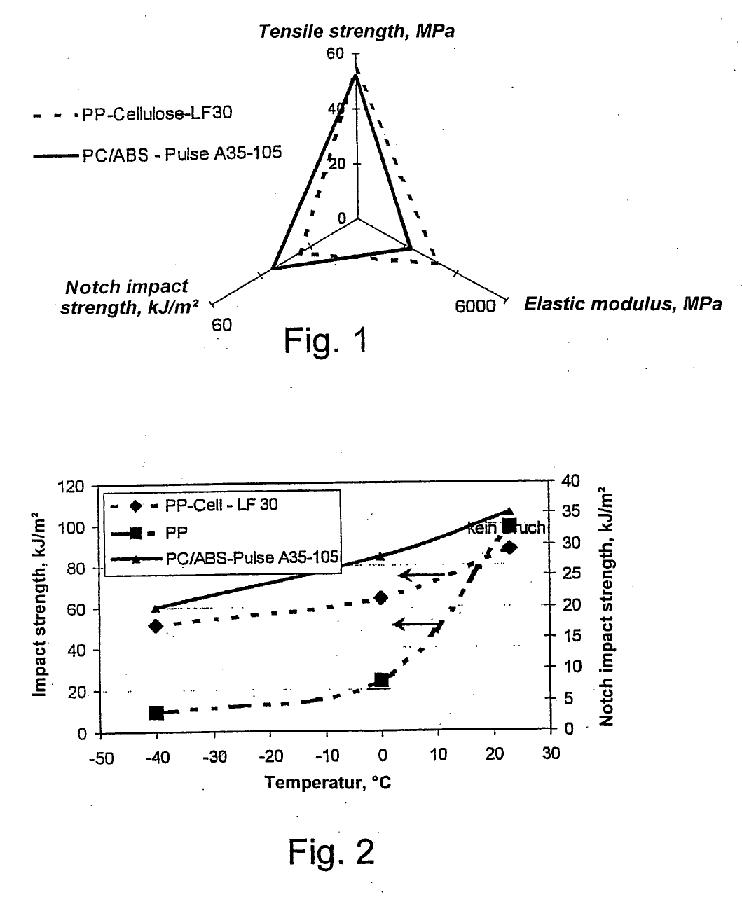

FIG. 1 this represents the resilience, tensile strength and elastic modulus, and

FIG. 2 this represents the impact strength or resilience related to the temperature of the respective material.

FIG. 1 shows the tensile strength, resilience and the elastic modulus of PP-cellulose-LF30 according to the invention (composition: PP Stamylan 67 wt-%, Fusabond 3 wt-%, Cordenka 30 wt-%) and PC/ABS-Pulse A35/105 (trade name). Here it can be recognised that the tensile strength is practically the same (in the range between 50 and 60 MPa). The elastic modulus is even better for the PP-cellulose material according to the invention than for the corresponding PC/ABS; here the elastic modulus is above 3000 MPa. The notch impact strength of the two materials is also in a similar range. Here the values lie respectively in the region of 30 kJ/m², the value of the PP-cellulose according to the invention being somewhat below that of PC/ABS.

Overall, however, it can be established that the properties profile is very similar. Advantageous for the PP-cellulose material is here the lower processing temperature of approx. 200° C.

FIG. 2 shows the impact strength and/or notch impact strength of three materials over a temperature range from −40 to roughly +20° C. It can be seen here that the PP-cellulose material according to the invention and the PC/ABS show a substantially smooth course dropping only slightly at low temperatures. In contract to this, with pure polypropylene there is a great drop in the impact strength or notch impact strength in too low temperatures.

In respect of the numerical values or greater details of the courses, reference is expressly made to FIGS. 1 and 2 themselves.

The production of a moulded part according to the invention based on granules according to the invention is now explained with the aid of an example.

For the matrix material, as the engineering plastic is selected optimised PP block copolymer of the company DSM Stamylan P412 MN 10 having a density of 0.905 g/cm³ and a melt index (230° C., 50 Newton) of 170 dg/min. The matrix material contains moreover, as an adherence promoter, PP maleic anhydride grafted copolymer (MAPP), in this case statistical MAPP, Fusabond (registered trademark) P of the company DuPont having a grafting degree greater than 1% and a melt index of 450 g/10 min (190° C., 2.16 kg) is used and is added at a rate of 3% by weight to the engineering plastic. Moreover, as reinforcement, the high-strength cellulose fibre Cordenka (registered trademark) 700 of the company Acordis is added, having 1350 filaments and a linear density of 1.81 dtex.

To produce the granules, in a first step a pultrusion method is used in which a predetermined number of Cordenka yarn strands (practically continuous) is connected via a coating die to the melted PP-MAPP mixture. The number of strands determined the proportion of fibres which was between 24 and 42% by weight. A HAAKE-Rheocord 9000 with PTW 25 served as the extruder; the processing took place at a maximum extruder temperature of 215° C. and a die temperature of 200° C. After the strand had cooled, it was cut to lengths of 2 mm using a granulator. After drying (2 hours at 85° C.) the granules were extruded again in a second step (3 mm hole-type die) and granulated again and dried for 4 hours at 85° C. before further processing (this second extrusion step is not absolutely necessary).

The moulded parts were finally produced with the aid of an injection moulding machine (Arburg-Allrounder 270 M 500-90) at an injection temperature of 200° C. and an injection pressure of 400 to 700 bar.

1. A method for producing granules for producing moulded parts, wherein continuous regenerated cellulose fibres are coated in a pultrusion process with a matrix material of an engineering plastic and an adherence promoter and then granulated, and after subsequent drying are extruded again and granulated and dried anew.

2. A method according to claim 1, wherein the pultrusion process has one or more stages.

3. Granules produced according to the method of claim 1.

4. The granules according to claim 3, wherein the engineering plastic has a processing temperature of less than 240° C.

5. The granules according to claim 3, wherein the engineering plastic is selected from the group consisting of: a polyolefin, a polyolefin derivative, PVC and a polyamide.

6. The granules according to claim 3, wherein the fibre elements have a tensile strength of more than 400 MPa.

7. The granules according to claim 3, wherein the elongation at break of the fibre elements is more than 5%.

8. The granules according to claim 3, wherein the granules contain 10-90% by weight fibre elements.

9. The granules according to claim 3, wherein the adherence promoter is a maleic acid copolymer or an isocyanate derivative.

10. The granules according to claim 3, wherein the granules contain up to 10% by weight adherence promoter.

11. The granules according to claim 3, wherein the granules contain ultraviolet stabilizers or further additives.

12. The granules according to claim 3, wherein the granules are present in lengths of 1 mm to 15 mm and the fibre elements contained therein are 1 mm to 15 mm long.

13. A moulded part which contains melted granules according to claim 3 in the solidified state.

14. The moulded part according to claim 13, wherein it has been produced by an injection moulding process.

15. The moulded part according to claim 14, wherein during the injection moulding process, the maximum temperature of the melted granules is 190-210° C. at an injection pressure of 50-700 bar.

16. The moulded part according to claim 13, wherein the fibre element pieces contained therein have a length of 1-8 mm.

17. The moulded part according to claim 13, wherein the fibre element pieces contained therein are predominantly more than 2 mm long, with 15-40% of the fibre element pieces being 1.5-5 mm long.

18. The moulded part according to claim 13, wherein it is designed for use in vehicle interiors.

19. The granules according to claim 3, wherein the elongation at break of the fibre elements is more than 8%.

20. The granules according to claim 3, wherein wherein the elongation at break of the fibre elements is more than 12%.

21. The granules according to claim 3, wherein the granules contain 20-42% by weight fibre elements.

22. The granules according to claim 3, wherein the granules contain 2-4% by weight adherence promoter.
